(19) United States
(12) Patent Application Publication
(10) Pub. No.: US 2003/0130872 A1
(43) Pub. Date: Jul. 10, 2003

(54) Methods and apparatus for managing and using inpatient healthcare information

(76) Inventors: Carl Dvorak, Madison, WI (US); Khiang Seow, Madison, WI (US); Cynthia Hess, Madison, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/304,822

(22) Filed: Nov. 26, 2002

Related U.S. Application Data
(60) Provisional application No. 60/333,617, filed on Nov. 27, 2001.

(51) Int. Cl. G06F 17/60

(52) U.S. Cl. 705/2; 705/3

(57) ABSTRACT

A method of creating a shift report for a healthcare provider in a hospital environment including creating an electronic shift note for a hospital patient, wherein creating the electronic shift note includes providing a content for the electronic shift note, saving the electronic shift note as a saved shift note, linking the saved shift note to an electronic medical record for the patient, and displaying the saved shift note to the healthcare provider via a user interface. Creating the shift report also includes creating a patient list based on a set of criteria, building the shift report based on the patient list, for each patient on the shift report having a saved shift note, adding the saved shift note to the shift report, and displaying the shift report including the added shift notes to the healthcare provider. Creating the shift report further includes providing the healthcare provider the ability to convert the saved shift note to a progress note, the progress note being a permanent addition to the patient's electronic medical record and deleting the saved shift note linked to the patient's electronic medical record when the patient is discharged from the hospital if the saved shift note was not converted to a progress note.

### CROSS-REFERENCE TO RELATED APPLICATIONS

This application claims priority to U.S. Provisional Application Serial No. 60/333,617, entitled “Method and Apparatus for Managing and Using Inpatient Healthcare Information,” filed Nov. 27, 2001 (attorney docket no. 29794/37827), the disclosure of which is hereby expressly incorporated herein by reference.

### TECHNICAL FIELD

The present patent relates generally to patient care and health record management, and more particularly, the present patent relates to methods and apparatus for managing and using inpatient healthcare information within an Electronic Medical Record (EMR) software system.

### BACKGROUND

Health care providers in an acute care setting need to communicate informal patient information at the time of a shift change, so that incoming staff members are advised of patient information that is not contained in a permanent medical record. This information gives them a concise summary of key facts and issues relating to the care of each patient. This information may include instructions that are less formal than orders placed for the patient but still essential to quality care, such as information concerning a patient's personality, details of diet and hygiene, or a reminder to water the plants in the patient's room. In general, this information does not need to be saved as part of a patient's permanent chart and would create confusion if it were to be included. In some cases, due to the tone of the notes, inclusion would be otherwise problematic, as in the case of candid or blunt cautions about a patient's demeanor.

As integrated enterprise solutions for the needs of healthcare organizations become increasingly viable, any aspect of the workflow for providing and documenting patient care that is not a part of the integrated system becomes a barrier to overall efficiency. Existing solutions perform unfavorably in several areas.

For example, with regard to the efficiency of communication, existing solutions unnecessarily require excessive man hours to create and disseminate the contents of the Shift Notes. Additionally, existing solutions are deficient in their ability to allow users to incorporate the creation and manipulation of notes into their workflows, particularly in the art of task management. Also, many solutions limit the user's access to the Shift Notes, with regard to both time and location. Existing solutions have also proved to be unsuccessful in providing a user the ability to easily edit notes and convert their content into a form that can be included into a patient's permanent medical record, should that become necessary.

A number of non-electronic means exist, by which acute care providers have communicated informal patient care information, including handwritten notes, recorded dictations, and personal communication if shift times overlap. While these means may be viable in many instances, they are prone to a variety of errors. For example, handwritten notes, especially the informal sticky notes typically used for Shift Notes, can easily be lost or confused one with each other. Notes written on sticky notes may also be difficult to read. Messages dictated on a cassette or similar medium cannot be easily communicated to more than one person in different locations. Either multiple individuals have to listen to recorded messages at a number of different times, or all individuals must be gathered at once to listen to the messages. Furthermore, personal, face-to-face communication is dependent on shift overlap, and does not allow new users to review the messages, as written notes do.

Existing methods, especially those requiring overlapping shifts to allow for face-to-face communication, consume large amounts of time, increasing payroll expenses without great improvements in patient care.

In some cases, the information communicated may not, at the time, appear to be of sufficient importance to warrant its being included in the patient's permanent medical record. However, later developments may cause providers to realize that the information should be recorded. For example, where a nurse notes a patient complaint that is later found to be a symptom of a condition that had not been originally diagnosed. The nurse's communication should be included in the patient record, but none of the existing solutions easily provide for this situation. Even if the communication is in written form in traditional systems, it is not recorded in such a manner that it can be included in the official record. Often, it is written informally on a self-adhesive notepad or piece of scratch paper, which is difficult to incorporate into a paper medical record and cannot be included at all in an electronic medical record (EMR).

When a healthcare organization employing one of the existing solutions employs an electronic medical record, the lack of integration between the existing solutions and the EMR becomes another failure of existing solutions. Users of multiple, non-integrated methods for scheduling tasks, recording Progress Notes and other records of patient care, and recording Shift Notes cannot easily use data from one method to complete tasks in another system. For example, users may need to copy manually data about a task to a Shift Note, to provide context for the note. If they later realize that the Shift Note should be preserved in the patient's permanent medical record, uses of non-integrated systems would then be forced to manually copy the same information into a Progress Note, wasting time at each step.

### BRIEF DESCRIPTION OF THE DRAWINGS

FIG. 1 is a block diagram of a general purpose data network.

FIG. 2 is a schematic diagram of an embodiment of a network computer.

FIG. 3 is a schematic diagram of several system components located in a healthcare facility.

FIG. 4 is an exemplary graphical user interface to access a Shift Report.

FIG. 5 is an exemplary flowchart representation of some of the steps used to create a Shift Report.

FIG. 6 is an exemplary flowchart representation of some of the steps used to write a Shift Note and add it to a Shift Report.

FIG. 7 illustrates an exemplary flowchart representation of some of the steps used to dictate a Shift Note and add it to a Shift Report.

FIG. 8 is an exemplary flowchart representation of some of the steps used in converting a task to a Shift Note.

FIG. 9 is an exemplary flowchart representation of some of the steps used in converting a Shift Note to a Progress Note.

### DETAILED DESCRIPTION OF THE PREFERRED EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

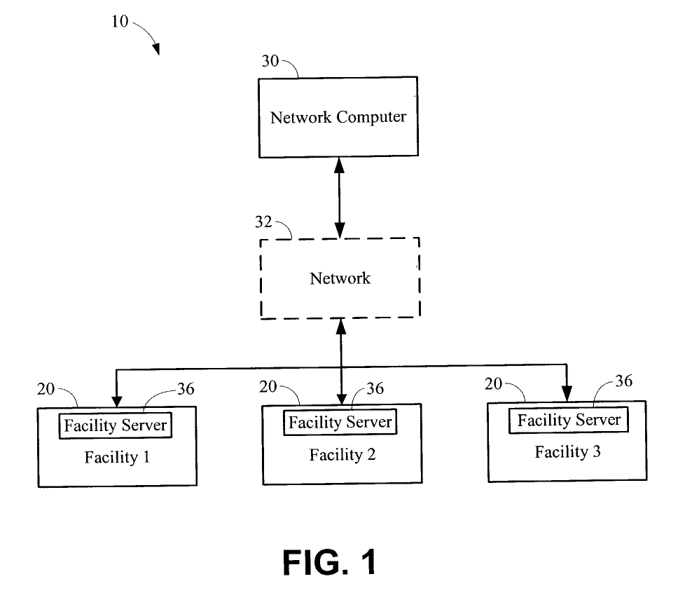

FIG. 1 illustrates an embodiment of an enterprise-wide data network 10 including a first group of healthcare facilities 20 operatively coupled to a network computer 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the enterprise-wide data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

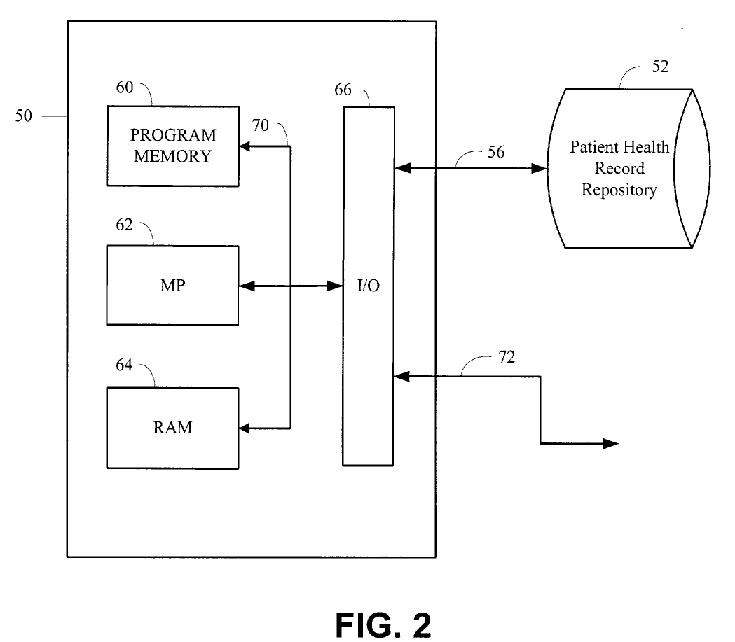

FIG. 2 is a schematic diagram of one possible embodiment of the network computer 30 shown in FIG. 1. The network computer 30 may have a controller 50 that is operatively connected to a patient health record repository 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

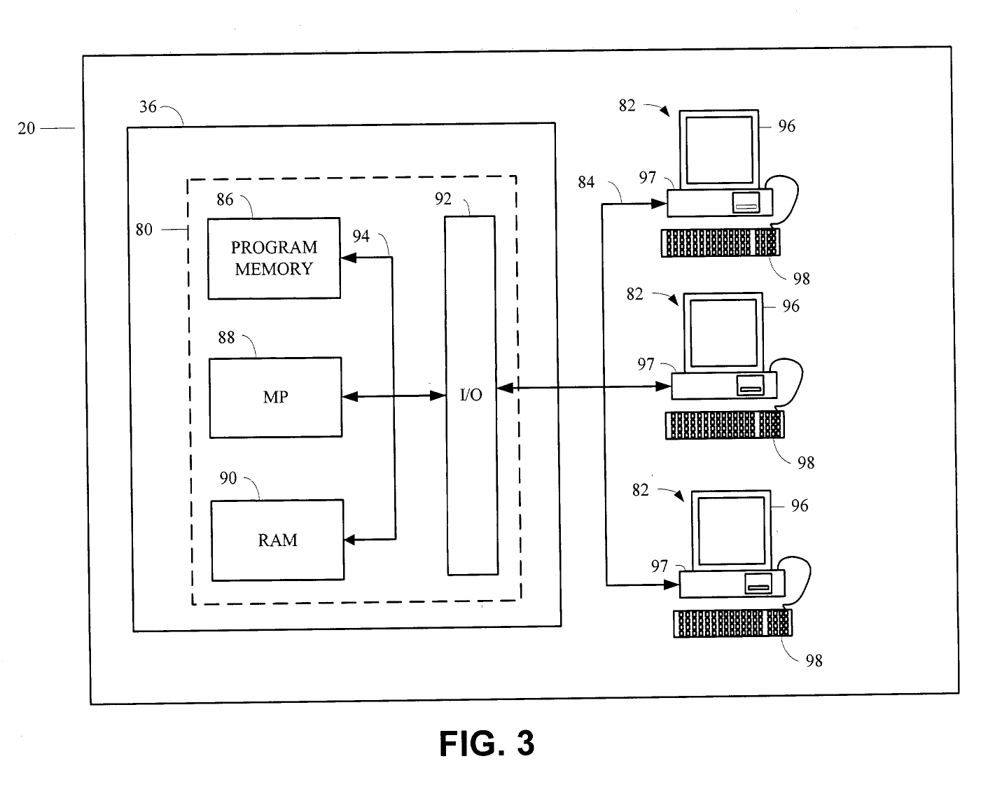

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility; however, it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple program memories 86. Although the I/O circuit 92 is shown as a single block, the I/O circuit 92 may include a number of different types of I/O circuits. The RAM(s) 90 and program memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

Overall Operation of the System One manner in which an exemplary system may operate is described below in connection with a number of flow charts which represent a number of portions or routines of one or more computer programs. These computer program portions may be stored in one or more of the memories in the controllers 50 and 80, and may be written at any high level language such as C, C++, or the like, or any low-level, assembly or machine language. By storing the computer program portions therein, various portions of the memories are physically and/or structurally configured in accordance with the computer program instructions.

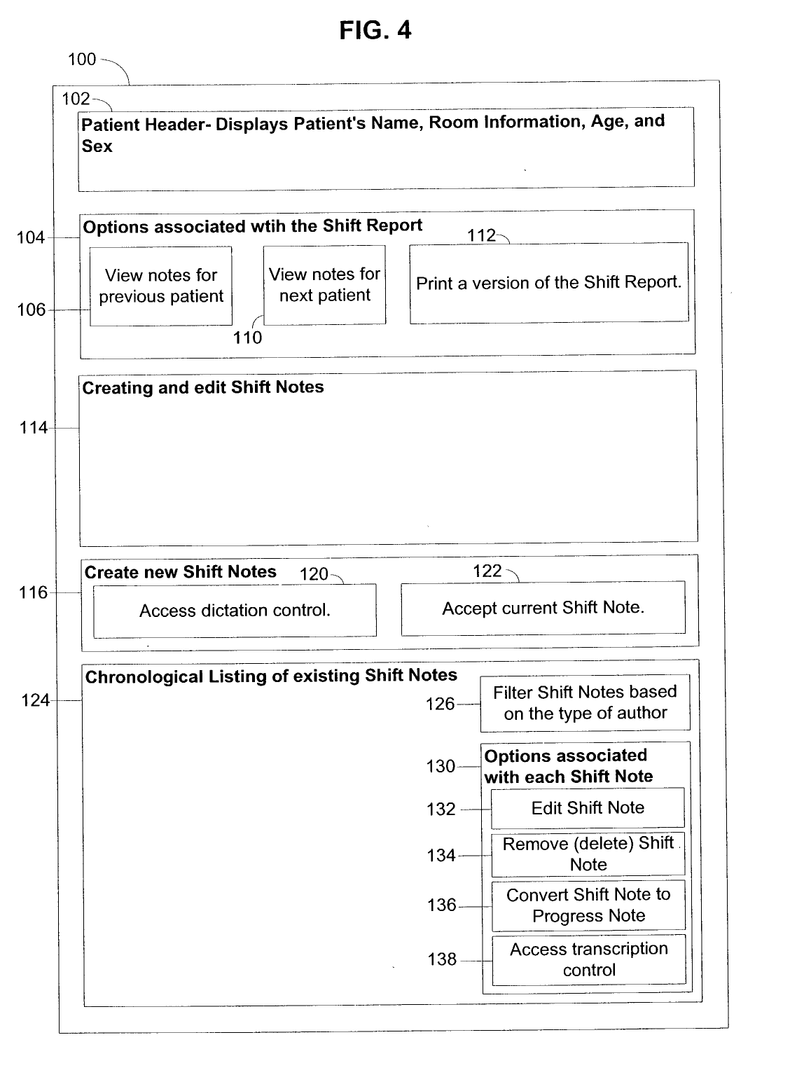

FIG. 4 is an exemplary embodiment of a user interface 100 that may be used to access a Shift Notes and a Shift Report. The Shift Report interface 100 presents the Shift Notes for one patient at a time. The patient is identified in a patient header (Section 102), which also displays rooming information for the patient and some basic demographic information, such as, for example, the patient's age and sex. As used herein, the term (Shift Note) is hereby defined to mean one of a set of notes written by physicians, nurses, and health care providers of various other disciplines used to document general observations on a patient's condition.

This diagram is a representation of one possible embodiment of a Shift Reports interface. One of a set of notes written by physicians, nurses, and healthcare providers of various other disciplines, used to document general observations on the patient's condition. Shift Notes may relate to patient care, but may also include observations and instructions that are not suitable for inclusion in the patient's permanent legal medical record. One example is a reminder to water plants that have been brought to the patient. Shift Notes may be written or dictated, and are typically not saved as part of the patient's permanent medical record.

An electronic report listing the Shift Notes written with regard to each member of a set of patients. The Shift Report may consist of a series of forms, such that each patient's Shift Notes appear on an individual form. Users of the Shift Report can cycle through the forms, reading the Shift Notes for each patient. A printed version of the Shift Report may include demographic and rooming information for each patient, along with the contents of the most recent Shift Note.

The Shift Report interface presents the Shift Notes for one patient at a time. Furthermore, as used herein, the term “Shift Report” is hereby defined to refer to an electronic report listing the Shift Notes written with regard to each member of a set of patients. This patient is identified in the Patient Header, which also displays rooming information for the patient and some basic demographic information, such as the patient's age and sex.

Below the Patient Header 102 is an array of options in a Section 104 that affect the Shift Report, rather than a single Shift Note. These options include navigational choices 106 and 110 to select different patients in the Shift Report and an option to generate a printed version of the Shift Report in Section 112. The printed version of the Shift Report may contain an entry for each patient in the Shift Report, which may include the information in the Patient Header, followed by the contents of the most recent Shift Note. It should also be noted that if the most recent Shift Note was dictated, it cannot, of course, be printed, unless it has since been transcribed. A notification message may be printed instead.

Below the Shift Report Section 104, is a large pane 114 that may be used to create and edit written Shift Notes. This section allows a user to provide a content, in writing, for the Shift Note. Across the top of the pane 114, a series of buttons that may provide users with options to more easily create Shift Notes. For example, these options enable users to: open a larger window to enter Shift Notes; perform a spell check; undo the last action; re-do the most recently undone action; insert a phrase or link using an automatic ShortText segment tool or an automatic text retrieval tool; create a new phrase using the automatic ShortText segment tool; insert a block of text using an automatic LongText segment tool; navigate imbedded lists using an imbedded pick list tool.

The automatic ShortText segment tool, the automatic text retrieval tool, automatic LongText segment tool, and the imbedded pick list tool are features that may be used to allow users to insert standardized blocks of text into notes and other documentation. Phrases generated using the automatic ShortText segment tool are short segments of text. Links generated using the automatic text retrieval tool are blocks of text that retrieve information from a patient's record. Text generated using the automatic Long Text segment tool are larger blocks of text. Lists generated using the imbedded pick list tool are pick lists imbedded in text created using the imbedded pick list tool that provide standardized responses to complete the documentation.

Below the pane 114 used to create and edit Shift Notes is a section 116 that includes options for creating Shift Notes. One option allows users to open a dictation control and record a verbal Shift Note (section 120). Another option accepts the contents of written Shift Notes and transfers written Shift Notes to the list of existing Shift Notes (section 122).

The list of existing Shift Notes is located at a bottom section 124 of the interface 100. The Shift Report presents an option to filter the listing of Shift Notes, to include those Shift notes written by particular types of users at a section 126. Each user is defined in the system as a particular type of provider, such as a surgeon or physical therapist, and the Shift Report can be filtered to include or exclude notes written by different types of providers. This adds considerable value to printed Shift Reports, in that they can be filtered to only include the most recent note by a user of the same type as the person printing the report. Filtering the Shift Report also increases a user's efficiency in reading the Shift Notes, as Shift Notes that do not relate to the user's job can be filtered from the report.

By default, Shift Notes are sorted in chronological order, with the most recent Shift Note appearing at the top of the list. Shift Notes are introduced with the time and date the Shift Note was accepted and the user who entered the Shift Note. Each Shift Note has a set of options associated with it. These options vary based on the type of note and whether the current user is the author of the Shift Note. These options are shown at a section 130 and allow users to: edit written Shift Notes, if the user is the author (section 132); remove the Shift Note from the Shift Report (section 134); convert the Shift Note to a Progress Note (section 136) (Unlike Shift Notes, Progress Notes are a part of the patient's permanent medical record); and open the transcription control to play back dictated Shift Notes

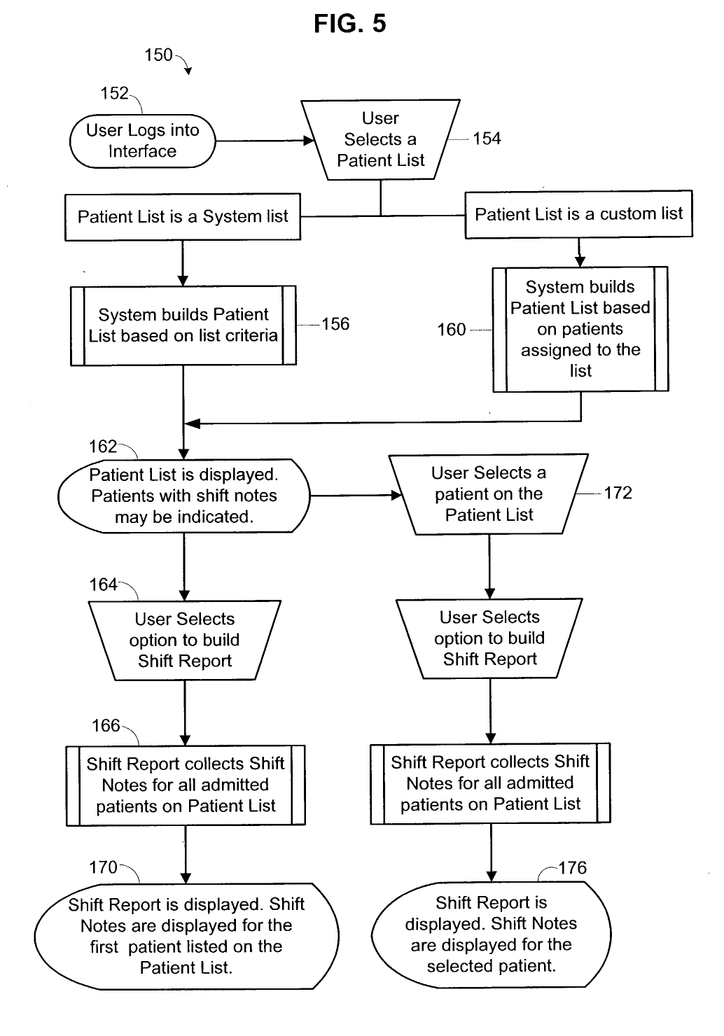

FIG. 5 is an exemplary flowchart 150 representation of some of the steps used to create a Shift Report. Each Shift Report is based on a Patient List, and includes the same set of patients as identified on the Patient List. As used herein, the term “Patient List” is defined to describe a listing of patients, from which a Shift Report or Work List (described below) is built. Shift Notes can be written about each admitted patient on a Patient List, and those Shift Notes are collected into the Shift Report. Two types of Patient Lists include: system-level Patient Lists and custom Patient Lists. System level Patient Lists are defined by certain criteria, and include patients who fit the list's criteria. The list is updated automatically, adding and removing patients as necessary. An example of a System-level Patient Lists is a floor or service census, which contains patients roomed or treated in a particular location, such as rooms covered by a nurse's station. Another example of a system level Patient List is a list of patients based on their relationship to a provider, such as all the patients for whom the provider is the attending physician, consulting physician, or primary care provider (PCP). Custom Patient Lists are built by users and include patients selected by the users of the list.

As defined herein, the term “Work List” is defined to mean a module in a larger clinical system that also contains a Patient List and a Shift Report. The Work List presents information on the set of patients included in a Patient List. This information includes basic demographics and room assignments, plus any tasks assigned to the patient. Tasks can be generated by an internal process in response to orders, medications, or care plan interventions for each patient, and can also be manually entered from the Work List. Each task that is assigned to a patient can be marked to appear as a Shift Note on the Shift Report.

When a user logs into the interface 100 and accesses the Patient List feature (block 152), a number of Patient Lists are available. When one is selected (block 154), the patients are collected for the Patient List according to the type of Patient List. Two types of Patient Lists are illustrated in FIG. 5. One type of Patient List is a system-level Patient List (block 156) which is defined by certain criteria, and includes patients who fit the list's criteria. The list may be updated automatically, adding and removing patients as necessary. Another type of Patient List is a custom Patient List (block 160), which is built by users and includes patients selected by the users of the list.

Once the Patient List is built and displayed (block 162), the user may be given the option of building a Shift Report based on that Patient List. When that option is selected (block 164), the Shift Report creates a report form for each admitted patient on the selected Patient List (block 166). Each form contains the accepted Shift Notes for the patient. The Shift Report organizes these forms in the same order as the patients are listed on the Patient List (block 170) and the Shift Report is displayed. It should be noted that the Shift Notes are displayed for the first patient listed on the Patient List. If an admitted patient is selected in the Patient List (block 172), that patient's form is displayed when the Shift Report opens (block 176). If no patient is selected in the Patient List, or the selected patient is not admitted, the Shift Report opens by default to the form for the first admitted patient found on the Patient List (block 170).

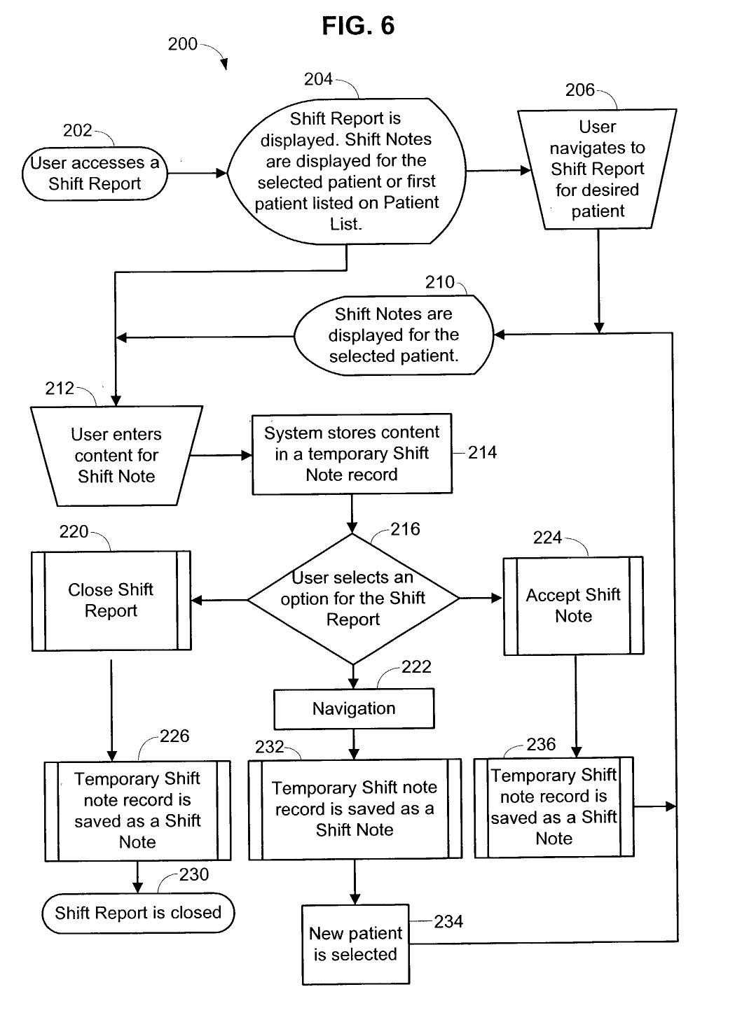

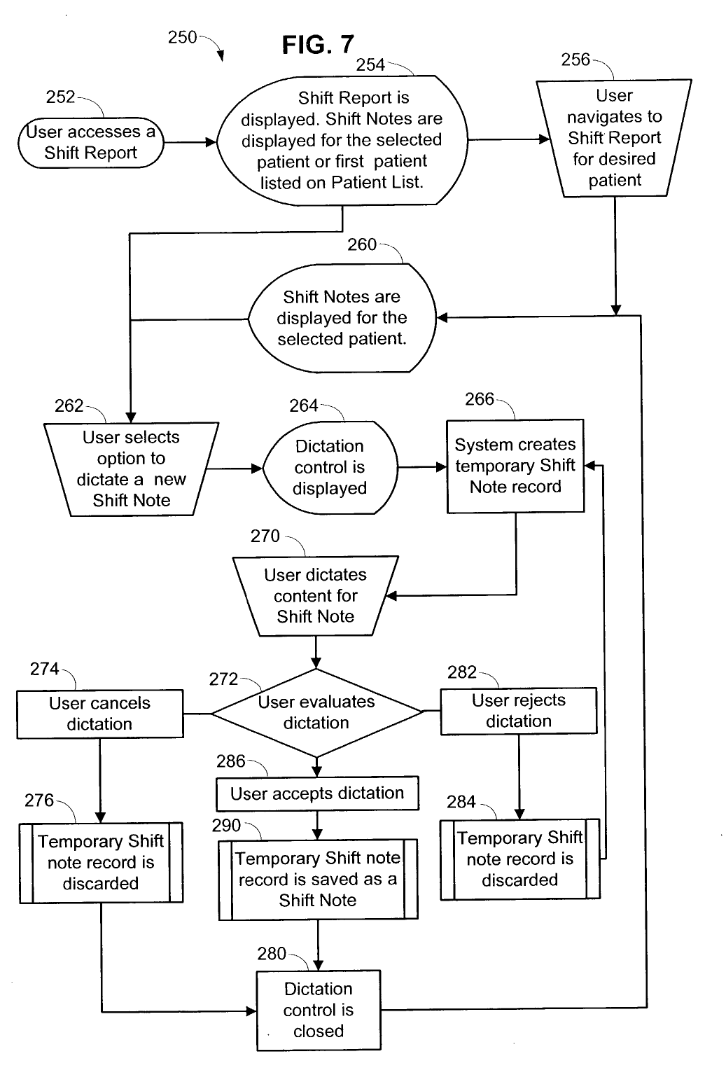

FIG. 6 is an exemplary flowchart 200 representation of some of the steps by which an electronic Shift Note is written for a patient and added to a Shift Report. Refer to FIG. 7 for the process of dictating a Shift Note. The process of writing a Shift Note begins when a user logs into the application and accesses an electronic Shift Report (block 202). Thereafter, an electronic Shift Report is displayed (block 204) and electronic Shift Notes are also displayed for the selected patient or the first patient listed on the Patient List.

The user logs into the application and accesses a Shift Report. If the desired patient is not displayed in the Shift Report, the user can navigate to the correct patient (block 206). Once the correct patient is selected, the user can view the existing Shift Notes for that patient (block 210).

To start the creation of a new Shift Note, the user simply begins typing the content of the note in the area 114 for creating and editing Shift Notes in the Shift Report interface 100 (block 212). As mentioned in the description of FIG. 4, the user has a number of specialized tools available to assist in the creation of the Shift Note. The content of the Shift Note is stored in a temporary Shift Note record (block 214).

The new Shift Note is not added to the Shift Report until the user takes some action. It may be determined at a block 216 that the user can close the Shift Report (block 220), navigate to the form for another patient (block 222), or accept the Shift Report (block 224). If the user chooses to close the Shift Report (block 220), then the temporary Shift Note record is saved as a saved Shift Note (block 226), linked to the patient's EMR, and the Shift Report is closed (block 230). If the user chooses to navigate through the form for another patient (block 222), then the temporary Shift Note record is saved as a saved Shift Note (block 232) and linked to the patient's EMR, wherein the new patient is selected (block 234) and the Shift Notes for that selected patient are displayed (block 210). If the user chooses to accept the Shift Note (block 224), then the temporary Shift Note record is saved as a saved Shift Note (block 236) wherein the Shift Notes are displayed for the selected patient (block 210). It should also be noted that the new saved Shift Note is linked to the patient's EMR and appears at the top of the list of the patient's existing Shift Notes.

FIG. 7 is an exemplary flowchart 250 representation of some of the steps used to dictate a Shift Note for a patient and adding that dictated Shift Note to a Shift Report. Refer to FIG. 6 for the process of writing a Shift Note.

The process described in the flowchart 250 begins when a user logs into the application and accesses a Shift Report (block 252). The Shift Note is then displayed (block 254) for the selected patient or the first patient listed on the Patient List. If the desired patient is not displayed in the Shift Report, the user can navigate to the correct patient (block 256). Once the correct patient is selected, the user can view the existing Shift Notes for that patient (block 260).

To start the creation of a new dictated Shift Note, the user selects the option to open the dictation control (block 262), wherein the dictation control is displayed (block 264). From the dictation control, the user has options to start recording, stop recording, play back the recording, and erase the recording the system creates a temporary Shift Note record to temporarily store the content of the dictation until a further action is taken. The user then dictates the content for the Shift Note (block 270) and evaluates the dictation (block 272). If the user cancels the dictation (block 274), the temporary Shift Note record is discarded (block 276) and the dictation control is closed (block 280). If the user rejects the dictation (block 282), the temporary Shift Note record is discarded (block 284) and the system provides the user with the ability to dictate another Shift Note (block 256). If the user chooses to accept the dictation (block 286), the temporary Shift Note record is saved as a saved Shift Note (block 290) and the dictation control is closed (block 280). It should also be noted that if the user closes the dictation interface without accepting the dictation, the temporary file is deleted.

Once the saved Shift Note is accepted, it is assigned to the patient, and is available to other users. The new Shift Note is linked to the patient's EMR and appears at the top of the list of that patient's existing saved Shift Notes. As with written Shift Notes, the time, date, and creator of a dictated Shift Note are displayed. Since the content of the Shift Note cannot be displayed visually, the listing of the Shift Note contains an option to open a transcription control to play back the dictated Shift Note.

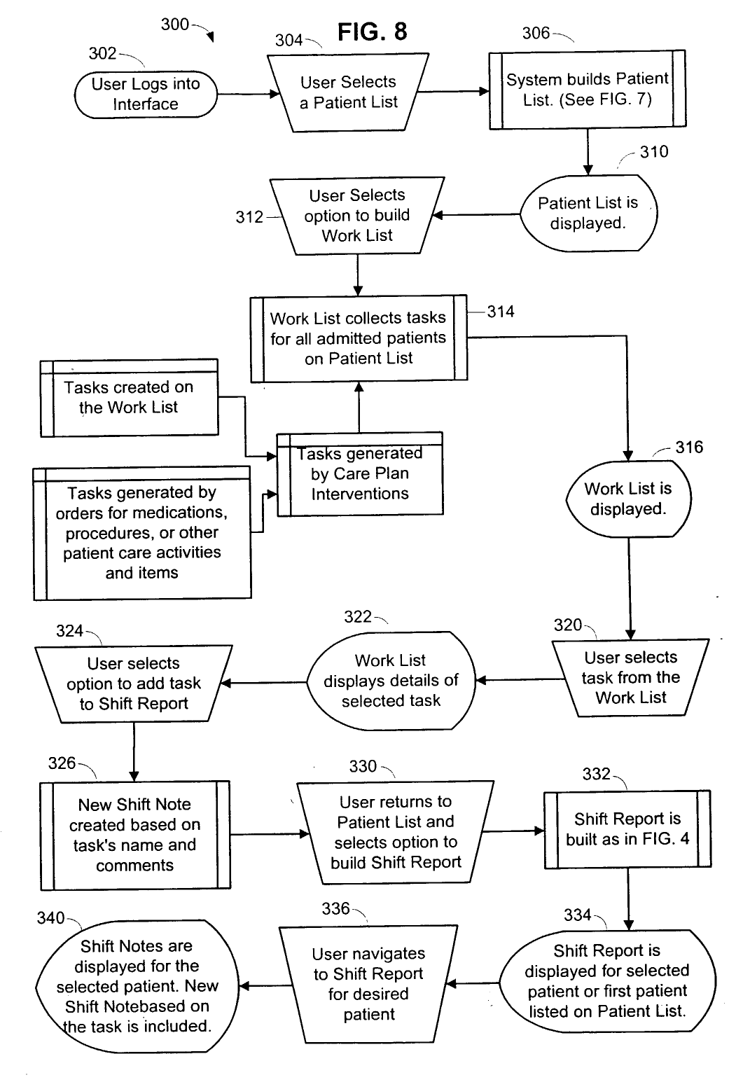

FIG. 8 is an exemplary flowchart 300 representation of some of the steps used to create a Shift Note based on a task. The system and method for generating Shift Notes may be a part of a larger clinical system, which contains a related module known as a Work List. When procedures, tests, medications, care plan interventions, and other orders are placed in the system, the system can generate tasks on the Work List that instruct providers to carry out the orders. Tasks can also be manually created on the Work List. Tasks are assigned to patients, and Work Lists are based on Patient Lists, just as Shift Reports are based on Patient Lists. When an appropriate provider opens a Work List, the tasks that that provider can complete are displayed for each patient. Since the tasks are usually performed by nursing staff, and may contain rather routine procedures, they are frequently the topics of Shift Notes.

In the process of creating a Shift Note based on a task, the user logs into the system (block 302) through the interface 100 and accesses a Patient List (block 304). The system then builds a Patient List (block 306) and displays the Patient List to the user (block 310). The user then selects the option to build a Work List for the patients on the Patient List (block 312). The Work List retrieves all tasks assigned to the patients on the Patient List (block 314) and displays them on the Work List (block 316).

The user then selects a task from the Work List (block 320). The Work List opens a new display, consisting of the details of the task (block 322). The user selects an option on this new display to add the task to the Shift Report (block 324). When this is done, and the change is accepted, a new saved Shift Note is created for the patient to whom the task applies (block 326).

While the above steps are needed to create the Shift Note, the user most likely will want to add additional content to the note, and is returned to the Patient List from the Work List (block 330), where the user builds a Shift Report for that Patient List, or any other Patient List containing the patient to whom the new Shift Note applies (block 332). The Shift Report is displayed for the selected patient or the first patient listed on the Patient List (block 334). The user navigates to the Shift Report for the desired patient (block 336). The Shift Notes are displayed for the selected patient and the new Shift Note based on the task is included (block 340). It should also be noted that when the user views the Shift Notes for the selected patient, the most recent Shift Note contains the time and date the task was converted to a Shift Note, the name of the user who converted it, the title of the task, and any comments associated with the task.

Shift Notes converted from tasks can be edited, deleted, and converted to Progress Notes just like any other written Shift Note. Converting a task to a Shift Note does not remove the task from the Work List. It should be noted that as used herein, the term “Progress Notes” describes one of a set of notes written by physicians, nurses, and healthcare providers of various other disciplines, used to document general observations on the patient's condition. Progress Notes are focused on patient care, may document such things as symptoms, reactions to procedures, and details of healthcare encounters, and are recorded as a part of the patient's permanent medical record.

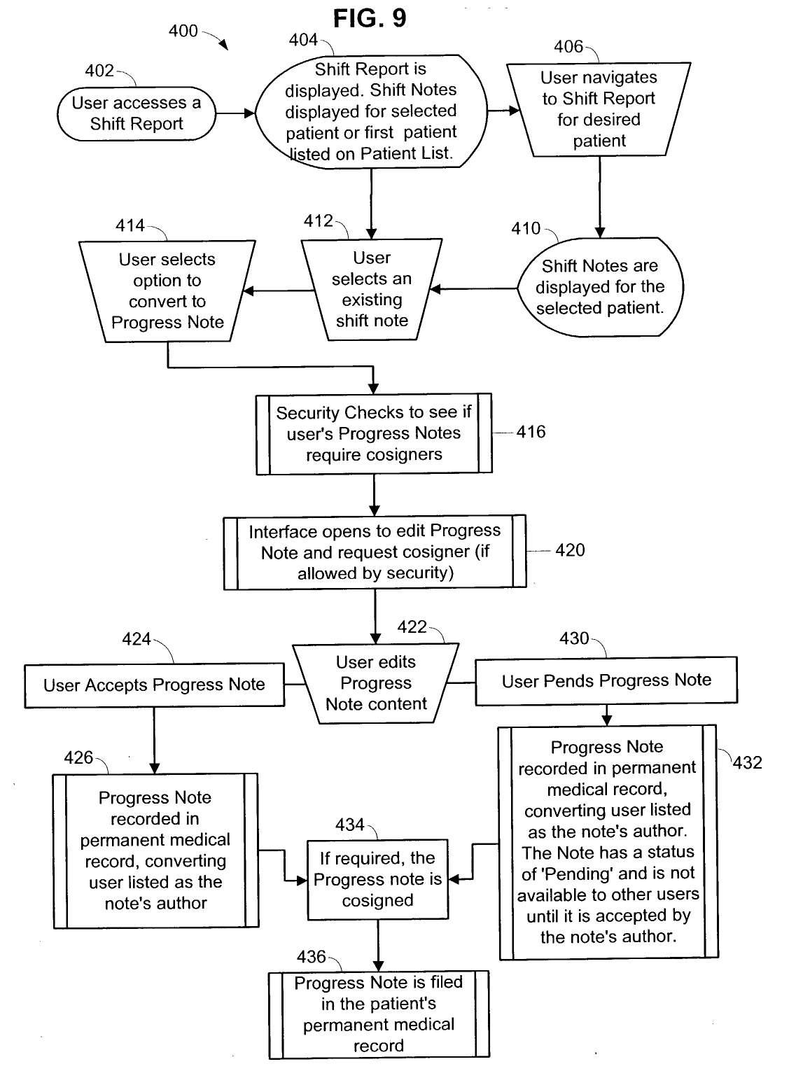

FIG. 9 is an exemplary flowchart 400 representation of some of the steps used in a process by which a Shift Note is converted to a Progress Note. Shift Notes appear on the Shift Report and are deleted when the patient is discharged. Progress Notes appear in the patient's electronic medical record (EMR) and are recorded as a permanent part of the patient's medical record.

The process of converting a Shift Note to a Progress Note begins when a user logs into the system and accesses a Shift Report (block 402). The Shift Report is then displayed, wherein the Shift Notes are displayed for the first patient listed on the Patient List (block 404). If the Shift Report does not display Shift Notes for the correct patient, the user navigates to the Shift Report frame for the correct patient (block 406). The Shift Notes are then displayed for the selected patient (block 410).

Once the Shift Notes for the patient are displayed, the user selects a Shift Note (block 412) and chooses the option to convert the Shift Note to a Progress Note (block 414). Security then checks to see if the user's Progress Notes require cosigners (block 416) and an interface opens, allowing the converting user to edit the contents of the note, if allowed by security (block 420). As with editing a Shift Note, automatic text completion tools and other RTF-formatting tools may be available when editing the Progress Note. The Progress Note can also be set to require a cosigner to verify the content of the note.

The user finalizes the content and formatting of the note and determines if it requires a cosigner (block 422). (Depending on the user's security, all the user's notes may require a cosigner.). The user then accepts or pends the Progress Note. If the user accepts the Progress Note (block 424), the note immediately appears in the patient's medical record and can be seen by other users (block 426). If the user pends the Progress Note (block 430), however, the note is not available to other users until the user accepts the note (block 432). If required, the Progress Note is then cosigned (block 434). Once the Progress Note has been accepted and cosigned, it is filed as a part of the user's permanent medical record (block 436).

The Progress Note then appears in the Notes section of the EMR. Converted Notes are stamped with the time and date they were converted, along with the name of the user who converted the note. The author of the original Shift Note is not recorded, since the converting user may have significantly edited the Shift Note before converting it to a Progress Note.

As a part of the permanent record, the Progress Note cannot be edited, but addenda may be added to it. The Shift Note is not altered by the conversion. It is possible for a user to convert a Shift Note to a Progress Note, edit the Shift Note in the Shift Report interface, and convert the edited Shift Note to a second Progress Note.

Although the technique for creating, editing, and communicating Shift Notes via an integrated clinical health care information system described herein is preferably implemented in software, it may be implemented in hardware, firmware, etc., and may be implemented by any other processor associated with the organization. Thus, the routines described herein may be implemented in a standard multi-purpose CPU or on specifically designed hardware or firmware as desired. When implemented in software, the software routine may be stored in any computer readable memory such as on a magnetic disk, a laser disk, or other storage medium, in a RAM or ROM of a computer or processor, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

The invention has been described in terms of several preferred embodiments. It will be appreciated that the invention may otherwise be embodied without departing from the fair scope of the invention defined by the following claims.

1. A method of creating a shift report for a healthcare provider in a hospital environment comprising the steps of:
creating an electronic shift note for a hospital patient, including
providing a content for the electronic shift note,
saving the electronic shift note as a saved shift note,
linking the saved shift note to an electronic medical record for the patient, and
displaying the saved shift note to the healthcare provider via a user interface;
creating a patient list based on a set of criteria;
building the shift report based on the patient list, for each patient on the shift report having a saved shift note, adding the saved shift note to the shift report;
displaying the shift report including the added shift notes to the healthcare provider;
providing the healthcare provider the ability to convert the saved shift note to a progress note, the progress note being a permanent addition to the patient's electronic medical record; and
deleting the saved shift note linked to the patient's electronic medical record when the patient is discharged from the hospital if the saved shift note was not converted to a progress note.

2. The method of claim 1, wherein the step of providing the content for the electronic shift note comprises adding text utilizing an input device.

3. The method of claim 2, comprising the step of adding text utilizing a keyboard.

4. The method of claim 2, comprising adding text with an automatic text tool.

5. The method of claim 1, wherein the step of providing the content for the electronic shift note comprises dictating an audio message.

6. The method of claim 1, wherein the step of providing the content for the electronic shift note comprises importing information saved in the patient's electronic medical record.

7. The method of claim 6, comprising the step of importing information from a task into the electronic shift note.

8. The method of claim 1, further comprising the step of converting a task to a saved shift note.

9. The method of claim 1, further comprising the step of providing the healthcare provider the ability to filter the saved shift notes in the shift report.

10. The method of claim 9, comprising the step of filtering the saved shift notes to include on the shift report only the saved shift notes pertinent to the healthcare provider.

11. The method of claim 1, wherein the step of displaying the saved shift note comprises displaying the time, date, and creator of the saved shift note.

12. The method of claim 1, further comprising the step of storing the content for the electronic shift note in a temporary shift note record.

13. The method of claim 1, further comprising the step of providing the healthcare provider the ability to manipulate the content of the electronic shift note.

14. The method of claim 1, further comprising the step of providing the healthcare provider access to the shift report from a plurality of locations within the hospital.

15. The method of claim 1, further comprising the step of displaying the patient list to the healthcare provider.

16. A method of creating an inpatient shift report for a healthcare provider comprising the steps of:
creating an electronic shift note for a hospital patient, including
providing a content for the electronic shift note,
saving the electronic shift note as a saved shift note,
linking the saved shift note to an electronic medical record for the patient, and
displaying the saved shift note to the healthcare provider via a user interface, including displaying the time, date, and creator of the saved shift note;
creating a patient list based on a set of criteria;
building the shift report based on the patient list, for each patient on the shift report having a saved shift note, adding the saved shift note to the shift report;
displaying the shift report including the added shift notes to the healthcare provider;
providing the healthcare provider the ability to filter the saved shift notes in the shift report;
providing the healthcare provider the ability to convert the saved shift note to a progress note, the progress note being a permanent addition to the patient's electronic medical record; and
deleting the saved shift note linked to the patient's electronic medical record when the patient is discharged from the hospital if the saved shift note was not converted to a progress note.

17. The method of claim 16, wherein the step of providing the content for the electronic shift note comprises adding text utilizing an input device.

18. The method of claim 16, wherein the step of providing the content for the electronic shift note comprises dictating an audio message.

19. The method of claim 16, wherein the step of providing the content for the electronic shift note comprises importing information saved in the patient's electronic medical record.

20. The method of claim 19, comprising the step of importing information from a task into the electronic shift note.

21. The method of claim 16, comprising the step of filtering the saved shift notes to include on the shift report only the saved shift notes relevant to the healthcare provider.

22. The method of claim 16, further comprising the step of providing the healthcare provider the ability to manipulate the content of the electronic shift note.

23. A system for creating a shift report for a healthcare provider in a hospital comprising:
means for creating an electronic shift note for a hospital patient, including
means for providing a content for the electronic shift note,
means for saving the electronic shift note as a saved shift note,
means for linking the saved shift note to an electronic medical record for the patient, and
means for displaying the saved shift note to the healthcare provider via a user interface;
means for creating a patient list based on a set of criteria;
means for building the shift report based on the patient list, wherein each patient on the shift report that has a saved shift note is added to the shift report;
means for displaying the shift report to the healthcare provider, the shift report including the added shift notes;
means for providing the healthcare provider the ability to convert the saved shift note to a progress note, the progress note being a permanent addition to the patient's electronic medical record; and
means for deleting the saved shift note linked to the patient's electronic medical record when the patient is discharged from the hospital if the saved shift note was not converted to a progress note.

24. The system of claim 23, wherein the means for providing the content for the electronic shift note comprises a means for adding text utilizing an input device.

25. The system of claim 24, wherein the content is added using an automatic text tool.

26. The system of claim 23, wherein the content is an audio message.

27. The system of claim 23, wherein the content for the electronic shift note is imported information retrieved from the patient's electronic medical record.

28. The system of claim 23, further comprising a means for providing the healthcare provider the ability to filter the saved shift notes in the shift report.

29. The system of claim 23, wherein the means for displaying the saved shift note includes a means for displaying the time, date, and creator of the saved shift note.

30. The system of claim 23, further comprising a means for providing the healthcare provider the ability to manipulate the content of the electronic shift note.

31. A system for creating an inpatient shift report for a healthcare provider comprising:
a controller having a processor and a memory operatively coupled to the processor;
a first software routine stored in the memory and adapted to be executed on the processor to execute the step of enabling the healthcare provider to provide a content for an electronic shift note;
a second software routine stored in the memory and adapted to be executed on the processor to execute the step of saving the electronic shift note as a saved shift note;
a third software routine stored in the memory and adapted to be executed on the processor to execute the step of linking the saved shift note to an electronic medical record for the patient;
a fourth software routine stored in the memory and adapted to be executed on the processor to execute the step of displaying the saved shift note to the healthcare provider via a user interface, including displaying the time, date, and creator of the saved shift note;
a fifth software routine stored in the memory and adapted to be executed on the processor to execute the step of providing the healthcare provider the ability to create a patient list based on a set of criteria;
a sixth software routine stored in the memory and adapted to be executed on the processor to execute the step of building the shift report based on the patient list, for each patient on the shift report having a saved shift note, adding the saved shift note to the shift report;
a seventh software routine stored in the memory and adapted to be executed on the processor to execute the step of displaying the shift report, including the added shift notes, to the healthcare provider;
an eighth software routine stored in the memory and adapted to be executed on the processor to execute the step of providing the healthcare provider the ability to convert the saved shift note to a progress note, the progress note being a permanent addition to the patient's electronic medical record; and
a ninth software routine stored in the memory and adapted to be executed on the processor to execute the step of deleting the saved shift note linked to the patient's electronic medical record when the patient is discharged from the hospital, if the saved shift note was not converted to a progress note.

32. The system of claim 31, further comprising a tenth software routine stored in the memory and adapted to be executed on the processor to execute the step of providing the healthcare provider the ability to filter the saved shift notes in the shift report.

33. The system of claim 31, wherein the first software routine is adapted to receive text from an input device.

34. The system of claim 31, wherein the first software routine is adapted to receive text from the healthcare provider using an automatic text tool.

35. The system of claim 31, wherein the first software routine is adapted to receive an audio message.

36. The system of claim 31, wherein the first software routine is adapted to receive information imported from the patient's electronic medical record.

37. The system of claim 31, further comprising a tenth software routine stored in the memory and adapted to be executed on the processor to execute the step of providing the healthcare provider the ability to manipulate the content of the electronic shift note.
